(19) United States
(12) Patent Application Publication
(10) Pub. No.: US 2020/0310463 A1
(43) Pub. Date: Oct. 1, 2020

(54) CARRIER SYSTEM, CARRIER CONTROL SYSTEM, AND CARRIER CONTROL METHOD

(71) Applicant: HITACHI INDUSTRIAL PRODUCTS, LTD., Tokyo (JP)

(72) Inventors: Fumiko BENIYAMA, Tokyo (JP); Nobutaka KIMURA, Tokyo (JP)

(21) Appl. No.: 16/762,949

(22) PCT Filed: Oct. 29, 2018
(86) PCT No.: PCT/JP2018/040061

§ 371 Date: May 11, 2020

(30) Foreign Application Priority Data
Nov. 15, 2017 (JP) 2017-219880

(51) Int. Cl. G05D 1/02

(52) U.S. Cl. CPC G05D 1/0297; B65G 1/1371; G05D 1/0212

(57) ABSTRACT

A carrier system including a plurality of carriers and a control unit, in which each carrier included in the plurality of carriers includes a sensor that detects an object, the control unit stores carrier information indicating a position of a first carrier of the plurality of carriers and transmits an instruction to check existence of a second carrier to the first carrier when identification information and a position of the second carrier of the plurality of carriers are input, the first carrier having received the instruction to check existence performs measurement by the sensor and transmits a result of the performed measurement to the control unit, and the control unit determines whether the input position of the second carrier is correct based on the result of measurement by the sensor received from the first carrier.

This application claims the priority of Japanese Patent Application No. 2017-219880, filed on Nov. 15, 2017, which is incorporated herein by reference.

### BACKGROUND OF THE INVENTION

### 1. Field of the Invention

The present invention relates to a technique for checking the self-position of an autonomous carrier in an autonomous mobile system.

### 2. Description of Related Art

With the recent expansion of the mail-order market and diversification of customer needs, the size of packages handled in distribution warehouses has been reduced. Along with this change, logistics services have become diversified and complicated, and work costs for collection and the like have increased. On the other hand, the working population is declining, and automation of work is required. As one method to improve the labor of workers, there is a warehouse system that introduces an unmanned carrier in a warehouse, in which the unmanned carrier enters under a shelf where products are stored and automatically carries each shelf to a specified position (for example, a place where a picker waits).

In order for the unmanned carrier to travel in the warehouse, it is necessary to sequentially grasp where the unmanned carrier is traveling in the warehouse, that is, the self-position. For this purpose, there are (1) a method of grasping the self-position by reading markers laid at regular intervals and (2) a method of grasping the self-position by comparing the shape data of the surrounding environment measured by a sensor mounted on the carrier with an environmental map. In the latter method, it is not necessary to modify the environment in advance, and therefore, less labor is required at the time of initial start-up, and it is possible to flexibly cope with expansion of the traveling area.

When autonomous movement stops due to an error while driving, in the case of the above (1), the current location can be specified by moving the carrier over a marker and reading the marker, and the movement can be restarted from there. In the case of the above (2), for example, as described in JP-A-2014-186694, it is disclosed an unmanned carrier that records the cause of a stop when autonomous movement is stopped, determines whether the autonomous movement can be continued from a current self-position based on the cause of the stop at the time of resuming the movement, and resumes the movement if possible or maintains a stopped state when impossible.

According to JP-A-2014-186694, it is determined whether autonomous movement can be restarted according to the cause of a stop. In the case of a stop cause (for example, a sensor error or a system error) that may not maintain the self-position of the carrier, it is determined that the autonomous movement cannot be restarted, and an operator must take measures such as returning to an initial position. If the traveling place of the carrier is narrow, there is no problem, but if the traveling place of the carrier is wide, labor for returning to the initial position is required. As described above, in JP-A-2014-186694, no consideration is given to a restart method when it is determined that a stop position and a restart position are different, and the movement cannot be restarted unless the carrier body is returned to a predetermined initial position.

The scene in which the stop position and the restart position are different may occur, for example, in the following cases. One example is that when an unexpected situation occurs, such as when loaded goods collide with another structure, the autonomous movement temporarily stops there, and the carrier is manually moved to a safe place before restarting autonomous movement. Another example is that an autonomous carrier stops due to an error in the carrier body, but it is difficult to recover on the spot, and after the carrier is manually removed from the place and recovery measures are performed elsewhere, the carrier restarts autonomous movement from another location.

When the autonomous movement is restarted from the destination after the autonomous movement stops and then the carrier is manually moved, it is necessary to grasp the current position at the time of the restart by some method.

Grasping the current location may be possible by comparing an electronic map with scan data, but if a target location is a vast area such as a warehouse, finding a place that can be matched with the scan data from the entire map is time consuming and impractical. In a place where similar shapes appear continuously, it is difficult to even find the place.

For this reason, it is necessary to give the current location by some method, and as an example, a method of specifying a position by the operator using input means is conceivable. However, in places where there are few landmarks, it may be difficult to specify the corresponding place on the map (plan view). There is a possibility that a human error such as an error in the specified place may occur, and the input position is not always correct.

### SUMMARY OF THE INVENTION

In order to solve the above-described problems, the present invention employs, for example, a configuration described in the claims. The present specification includes a plurality of means for solving the above problems, but for example, there is provided “a carrier system including a plurality of carriers and a control unit, in which each carrier included in the plurality of carriers includes a sensor that detects an object, the control unit stores carrier information indicating a position of a first carrier of the plurality of carriers and transmits an instruction to check existence of a second carrier to the first carrier when identification information and a position of the second carrier of the plurality of carriers are input, the first carrier having received the instruction to check existence performs measurement by the sensor and transmits a result of the performed measurement to the control unit, and the control unit determines whether the input position of the second carrier is correct based on the result of measurement by the sensor received from the first carrier”.

According to one embodiment of the present invention, even when the position of a carrier is changed after a stop and a stop position is different from a restart position, the carrier can restart the autonomous movement without returning to a predetermined return position. Since the movement is started after confirming that the position input by the operator is correct, it is possible to prevent an accident or an error due to an input error. Problems, configurations, and effects other than those described above will be clarified by the following description of the examples.

### BRIEF DESCRIPTION OF THE DRAWINGS

FIG. 1 is an explanatory diagram illustrating an example of a configuration of an autonomous carrier system in a warehouse or the like to which Example 1 of the present invention is applied;

FIG. 2 is an explanatory diagram illustrating an example of a configuration of the autonomous carrier system required to describe Example 1 of the present invention;

FIG. 3 is an explanatory diagram of a hardware configuration of the system according to Example 1 according to the present invention;

FIG. 4 is an explanatory diagram of an in-warehouse map stored by an overall control system according to Example 1 of the present invention;

FIG. 5 is an explanatory diagram of an environment map stored by each autonomous carrier according to Example 1 of the present invention;

FIG. 6 is an explanatory diagram of a node number and coordinate value correspondence table stored by the overall control system according to Example 1 of the present invention;

FIG. 7 is an explanatory diagram of a shelf arrangement stored by the overall control system according to Example 1 of the present invention;

FIG. 8 is an explanatory diagram of carrier information stored in the overall control system according to Example 1 of the present invention;

FIG. 9 is a flowchart illustrating processing executed when an error has occurred in the autonomous carrier in the warehouse to which Example 1 of the present invention is applied;

FIG. 10 is a sequence diagram illustrating processing in which a normal autonomous carrier checks an autonomous carrier in which an error has occurred in the warehouse to which Example 1 of the present invention is applied;

FIG. 11A is an explanatory diagram of a first example of a screen displayed by an output device of an input terminal according to Example 1 of the present invention;

FIG. 11B is an explanatory diagram of a second example of the screen displayed by the output device of the input terminal according to Example 1 of the present invention;

FIG. 11C is an explanatory diagram of a third example of the screen displayed by the output device of the input terminal according to Example 1 of the present invention;

FIG. 11D is an explanatory diagram of a fourth example of the screen displayed by the output device of the input terminal according to Example 1 of the present invention;

FIG. 12 is an explanatory diagram of destination candidates in route generation by the overall control system according to Example 1 of the present invention;

FIG. 13 is an explanatory diagram of a movement route generated by the overall control system according to Example 1 of the present invention;

FIG. 14 is an explanatory diagram of an example of the existence of an autonomous carrier confirmed by the autonomous carrier and the overall control system according to Example 1 of the present invention;

FIG. 15 is an explanatory diagram of another example of the existence of an autonomous carrier confirmed by the autonomous carrier and the overall control system according to Example 1 of the present invention;

FIG. 16 is an explanatory diagram of an example of the existence of an autonomous carrier confirmed by an autonomous carrier and an overall control system according to Example 2 of the present invention;

FIG. 17 is an explanatory diagram of an example of a screen displayed by an output device of an input terminal according to Example 2 of the present invention; and

FIG. 18 is a sequence diagram illustrating processing in which a normal autonomous carrier checks an autonomous carrier in which an error has occurred in the warehouse to which Example 2 of the present invention is applied.

### DESCRIPTION OF EMBODIMENTS

Hereinafter, embodiments of the present invention will be described with reference to drawings.

### Example 1

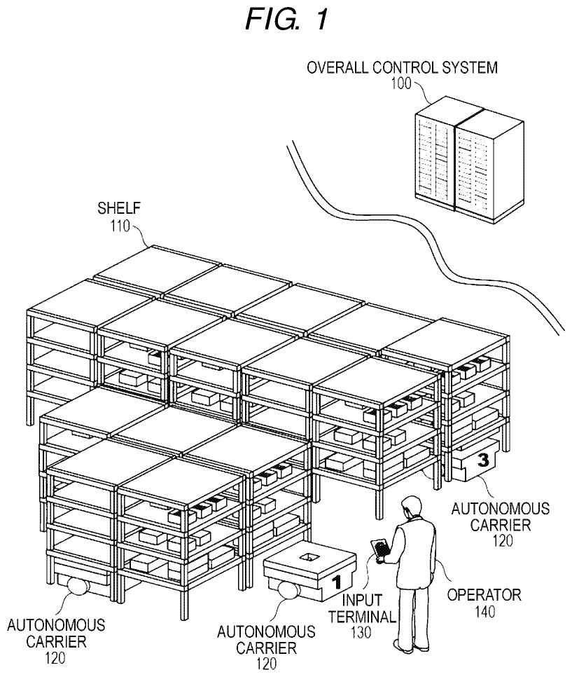

FIG. 1 is an explanatory diagram illustrating an example of a configuration of an autonomous carrier system in a warehouse or the like to which Example 1 of the present invention is applied.

An autonomous carrier system such as a warehouse to which the present example is applied includes, for example, an overall control system 100, a plurality of shelves 110, a plurality of autonomous carriers (hereinafter, also simply referred to as carriers) 120, and an input terminal. 130. Each shelf 110 stores articles stored in the warehouse. Each autonomous carrier 120 carries the shelves 110 according to instructions transmitted from the overall control system 100. For example, the autonomous carrier 120 carries the shelf 110 from a storage location thereof to a work location where picking and other operations are performed and carries the shelf 110 from the work location to the storage location after the picking and other operations are completed. Hereinafter, each of the plurality of autonomous carriers 120 may be described and distinguished as an autonomous carrier 120A and an autonomous carrier 120B as needed.

The overall control system 100 is a control unit that communicates with each autonomous carrier 120 and the input terminal 130 and controls the autonomous carrier 120. The overall control system 100 may be installed inside or outside the warehouse as long as the overall control system 100 can communicate with each autonomous carrier 120 and the input terminal 130.

The input terminal 130 receives input of information from an operator 140 and transmits the information to the overall control system 100. The input terminal 130 may output information received from the overall control system 100 to the operator 140.

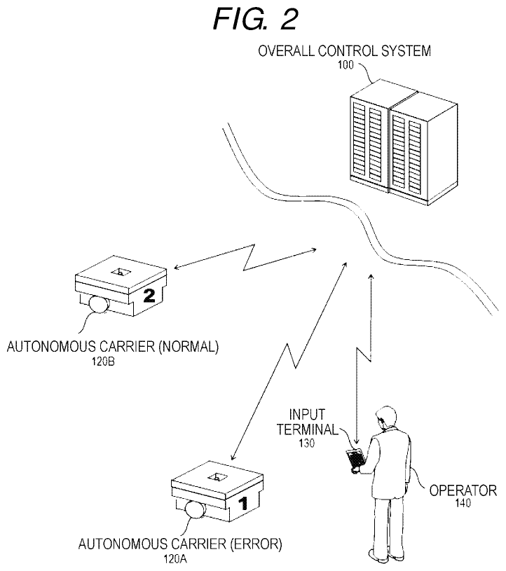

FIG. 2 is an explanatory diagram illustrating an example of the configuration of the autonomous carrier system required to describe Example 1 of the present invention.

The overall control system 100, the input terminal 130, and the operator 140 are the same as those illustrated in FIG. 1. The autonomous carriers 120A and 120B are each one of the plurality of autonomous carriers 120 illustrated in FIG. 1. In the example of FIG. 2, the autonomous carrier 120A has stopped because an error has occurred. On the other hand, the autonomous carrier 120B is operating normally.

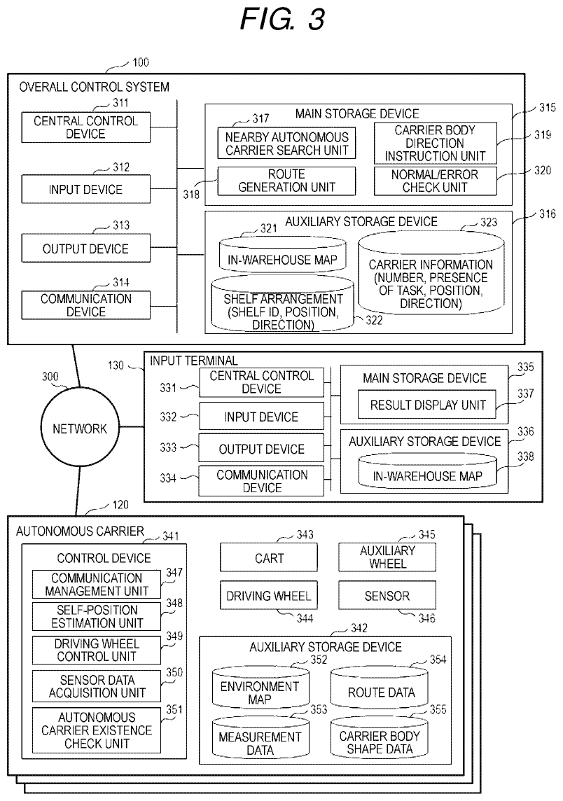

FIG. 3 is an explanatory diagram of a hardware configuration of the system according to Example 1 according to the present invention.

The overall control system 100, the input terminal 130, and the plurality of autonomous carriers 120 are communicably connected via a network 300. The network 300 may be of any type as long as the network 300 enables communication between the overall control system 100, the input terminal 130, and the plurality of autonomous carriers 120. Generally, at least a portion of the network 300 is a wireless network. For example, the network 300 may include a wireless base station (not illustrated), the autonomous carrier 120 and the input terminal 130 may perform wireless communication with the wireless base station, and the overall control system 100 may perform wired or wireless communication with the wireless base station.

The overall control system 100 is a computer including a central control device 311, an input device 312, an output device 313, a communication device 314, a main storage device 315, and an auxiliary storage device 316 connected to each other.

The central control device 311 is a processor that executes various kinds of processing by executing programs stored in the main storage device 315. The input device 312 is a device that receives input of information from a user of the overall control system 100, and may be, for example, a keyboard and a mouse. The output device 313 is a device that outputs information to the user of the overall control system 100, and may be, for example, a display device that displays characters and images. The communication device 314 is a device that communicates with the input terminal 130 and the autonomous carrier 120 via the network 300.

The main storage device 315 is a storage device such as a dynamic random access memory (DRAM), and stores a program executed by the central control device 311 and the like. The main storage device 315 illustrated in FIG. 3 stores a nearby autonomous carrier search unit 317, a route generation unit 318, a carrier body direction instruction unit 319, and a normal/error check unit 320. These units are programs executed by the central control device 311. Therefore, in the following description, the processing executed by each unit such as the nearby autonomous carrier search unit 317 is actually executed by the central control device 311 according to the program stored in the main storage device 315.

The auxiliary storage device 316 is a storage device such as a hard disk drive or a flash memory, for example, and stores information and the like necessary for processing executed by the central control device 311. The auxiliary storage device 316 illustrated in FIG. 3 stores an in-warehouse map 321, a shelf arrangement 322, and carrier information 323. At least a part of the information may be copied to the main storage device 315 as needed, and may be referred to by the central control device 311. Programs executed by the central control device 311 may be stored in the auxiliary storage device 316, and at least a part of them may be copied to the main storage device 315 as needed.

The input terminal 130 is a computer including a central control device 331, an input device 332, an output device 333, a communication device 334, a main storage device 335, and an auxiliary storage device 336, which are connected to each other.

The central control device 331 is a processor that executes various kinds of processing by executing programs stored in the main storage device 335. The input device 332 is a device that receives an input of information from the operator 140, and may be, for example, a keyboard, a mouse, a touch sensor, or the like. The output device 333 is a device that outputs information to the operator 140, and may be, for example, a display device that displays characters, images, and the like. The input device 332 and the output device 333 may be integrated like a so-called touch panel, for example. The communication device 334 is a device that communicates with the overall control system 100 via the network 300.

The main storage device 335 is a storage device such as a DRAM, for example, and stores programs executed by the central control device 331. The main storage device 335 illustrated in FIG. 3 stores a result display unit 337. The result display unit 337 is a program executed by the central controller 331. Therefore, in the following description, the processing executed by the result display unit 337 is actually executed by the central control device 331 according to the program stored in the main storage device 335.

The auxiliary storage device 336 is a storage device such as a hard disk drive or a flash memory, for example, and stores information and the like necessary for processing executed by the central control device 331. The auxiliary storage device 336 illustrated in FIG. 3 stores the in-warehouse map 338. The in-warehouse map 338 may be similar to the in-warehouse map 321 stored by the overall control system 100. At least a part of the information stored in the auxiliary storage device 336 may be copied to the main storage device 335 as needed and referred to by the central control device 331. A program executed by the central control device 331 may be stored in the auxiliary storage device 336, and at least a part of the program may be copied to the main storage device 335 as needed.

In the example of FIG. 3, the overall control system 100 and the input terminal 130 are different computers. For example, the overall control system 100 is a stationary computer, and need not always be installed near a warehouse. The input terminal 130 is, for example, a small and easily portable computer such as a so-called tablet terminal, and the operator can carry out data input and the like while moving through the warehouse with the terminal. However, such a configuration is an example, and the system of the present example may be configured by a computer having a different type form from the above. For example, the overall control system 100 and the input terminal 130 may be realized by one stationary or portable computer.

The autonomous carrier 120 includes a control device 341, an auxiliary storage device 342, a carriage 343, a drive wheel 344, an auxiliary wheel 345, and a sensor 346. The control device 341 is a device that controls the traveling and the like of the autonomous carrier 120, and includes a communication management unit 347, a self-position estimation unit 348, a drive wheel control unit 349, a sensor data acquisition unit 350, and an autonomous carrier existence check unit 351.

The communication management unit 347 manages communication with the overall control system performed via the network 300. The communication management unit 347 may include a communication device (not illustrated) that communicates with the overall control system via the network 300. The self-position estimation unit 348 estimates the self-position of the autonomous carrier 120 by comparing an environment map 352 with the sensor data acquired from the sensor 346. The drive wheel control unit 349 controls the rotation of the drive wheels 344 to make the autonomous carrier 120 travel. The sensor data acquisition unit 350 acquires data measured by the sensor 346. The autonomous carrier existence check unit 351 executes processing of checking the existence of another autonomous carrier 120 stopped due to an error.

Each unit in the control device 341 may be realized by dedicated hardware, but may be realized by a general-purpose processor (not illustrated) executing a program stored in a main storage device (not illustrated).

The auxiliary storage device 342 is a storage device such as a hard disk drive or a flash memory, for example, and stores information and the like necessary for processing executed by the control device 341. The auxiliary storage device 342 illustrated in FIG. 3 stores the environment map 352, measurement data 353, route data 354, and carrier body shape data 355.

The carriage 343 is a structure on which the control device 341, the auxiliary storage device 342, and the sensor 346 are equipped, and the drive wheel 344 and the auxiliary wheel 345 are mounted. Although omitted in FIG. 3, the cart 343 may be further equipped with a lift that lifts the shelf 110, a turntable that rotates the lifted shelf 110, a motor that drives the drive wheel 344, a battery that supplies power to the control device 341 and the motor, and the like.

The drive wheel 344 and the auxiliary wheel 345 are both mounted on the carriage 343, and support the autonomous carrier 120 by being in contact with the floor surface of the warehouse, and realize the travel of the autonomous carrier 120 by rotating each. Among these, the drive wheel 344 is connected to a power source such as a motor (not illustrated) and moves the autonomous carrier 120 by rotating by the power transmitted from the power source.

The sensor 346 is a device that detects a state around the autonomous carrier 120. For example, the sensor 346 is a laser distance sensor that measures the distance from the sensor 346 to an object, but may be another type of sensor as long as the sensor 346 can measure the distance to an object around the autonomous carrier 120.

In the present example, the sensor 346 is installed on one of the four side surfaces of each autonomous carrier 120, and normally, each autonomous carrier 120 travels in the direction of the side surface on which the sensor 346 is installed, while performing measurement by the sensor 346. For this reason, in the following description, the direction of the side surface on which the sensor 346 is installed is described as “front”, and the front side surface is also described as “front”. However, each autonomous carrier 120 may be able to travel in a direction other than forward, such as retreating backward, which is the opposite direction to the front. The following description illustrates an example in which one sensor 346 is installed on the front as described above, but in practice, the sensor 346 may be installed at a position other than the front (for example, at a corner of the autonomous carrier 120). A plurality of sensors 346 may be provided in one autonomous carrier 120, for example, a plurality of sensors 346 are provided on a plurality of surfaces or a plurality of corners.

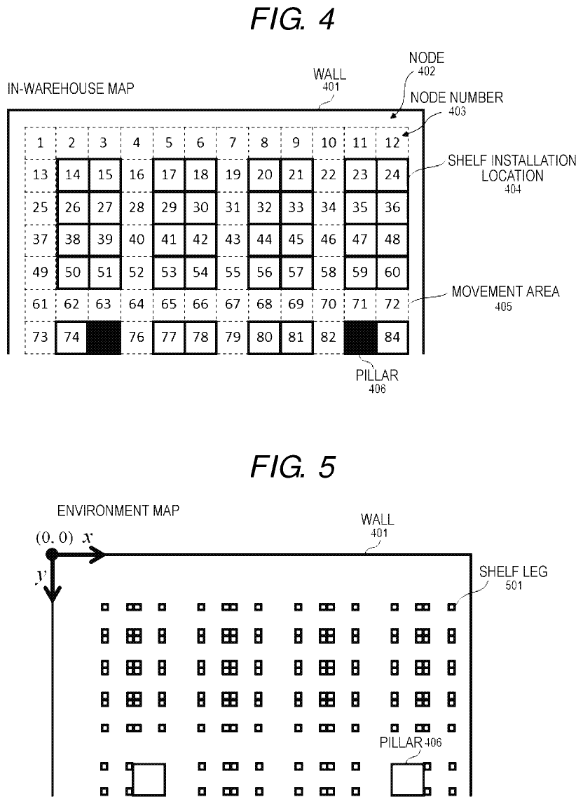

FIG. 4 is an explanatory diagram of the in-warehouse map 321 stored by the overall control system 100 according to Example 1 of the present invention.

The in-warehouse map 321 is a map of a space (a warehouse in the present example) in which the autonomous carrier 120 travels. As a representative method of representing a position in a warehouse, there are a method using a node and a method using a coordinate value. FIG. 4 illustrates a method using nodes as an example. Here, a node is a section of a predetermined size generated by dividing the space in the warehouse into a grid. FIG. 4 shows a plan view of a part of the space in the warehouse surrounded by a wall 401 as an example. The space in the warehouse is divided into a plurality of nodes 402, and each node is identified by a node number 403. In the example of FIG. 4, each square grid divided by a broken line or a solid line is one node 402, and “1” to “84” are displayed as node numbers 403 for identifying each node 402.

Each node 402 has a size that allows one shelf 110 to be installed. In the example of FIG. 4, each node 402 is classified into one of a shelf installation location 404 where the stored shelf 110 is installed and a movement area 405 used as a route for the shelf 110 to move between a work place and a shelf installation location for work such as picking and the like. There may be nodes that cannot be used as a shelf installation location or a movement area because of, for example, a pillar 406 of the warehouse.

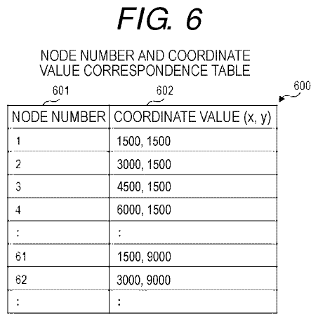

The in-warehouse map 321 includes at least information indicating the positional relationship between the nodes. The in-warehouse map 321 may further include information indicating whether each node is a node of a shelf installation location, a node of a movement area, or a node other than any of these. The in-warehouse map 321 may further include information (see FIG. 6) indicating the coordinate value of each node as described later.

FIG. 5 is an explanatory diagram of the environment map 352 stored by each autonomous carrier 120 according to Example 1 of the present invention.

The environment map 352 is a map referred to by the autonomous carrier 120 to grasp the self-position, and is prepared in advance. For example, the environment map 352 may be generated by the autonomous carrier 120 traveling in the warehouse, and collecting and integrating measurement data of the sensors 346 before the autonomous carrier 120 actually carries the shelves 110. The autonomous carrier 120 estimates the self-position by comparing the data measured by the sensor 346 with the generated environment map 352. The generation of the environment map 352 can be realized by a known method such as, for example, simultaneous localization and mapping (SLAM), and thus a detailed description is omitted.

Specifically, the environment map 352 includes the coordinates of the position of the object in the warehouse that can be detected by the sensor 346 of the autonomous carrier 120. In the example of FIG. 5, the coordinates of the positions of the legs 501 of each shelf 110, the wall 401 of the warehouse, and the pillar 406 in the warehouse are stored as the environment map 352.

FIG. 6 is an explanatory diagram of a node number and coordinate value correspondence table 600 stored by the overall control system 100 according to Example 1 of the present invention.

The node number and coordinate value correspondence table 600 illustrated in FIG. 6 is information for associating a node number for identifying each node 402 illustrated in FIG. 4 with a coordinate value 602 indicating the position of each node 402, and is stored in the auxiliary storage device 316. This information may be included, for example, in the in-warehouse map 321 or may be stored in the auxiliary storage device 316 independently of the warehouse map 321.

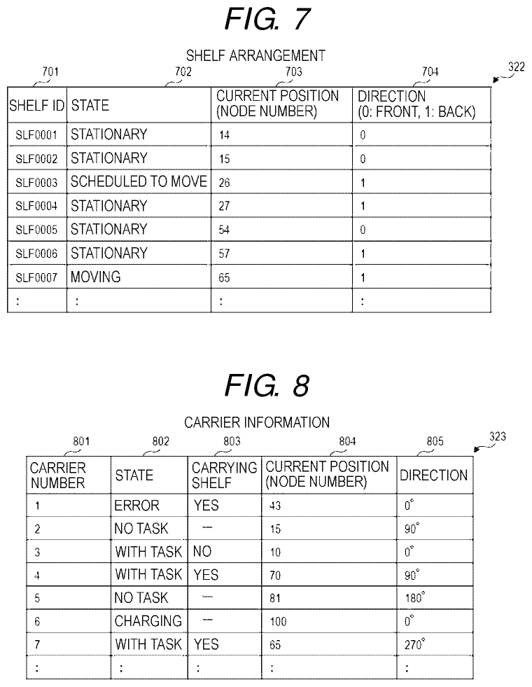

FIG. 7 is an explanatory diagram of the shelf arrangement 322 stored by the overall control system 100 according to Example 1 of the present invention.

The shelf arrangement 322 includes a shelf ID 701 for identifying each shelf 110, a current state 702 of each shelf 110, a current location 703 of each shelf 110, and a current location 704 of each shelf 110. Here, the state 702 indicates a state in which each of the shelves 110 is currently stationary, is moving, or is stationary but has a schedule to move from now. The current location 703 indicates the number of the node where each shelf 110 is currently placed. The direction 704 indicates, for example, which direction the front of each shelf 110 faces.

FIG. 8 is an explanatory diagram of the carrier information 323 stored by the overall control system 100 according to Example 1 of the present invention.

The carrier information 323 includes a carrier number 801 for identifying each autonomous carrier 120, a state 802, a carrying shelf 803, a current position 804, and a direction 805.

The carrier number 801 is a number for identifying each autonomous carrier 120.

The state 802 indicates the state of each autonomous carrier 120. “Error” indicates that an error has occurred in the autonomous carrier 120. A value other than “error” indicates that the autonomous carrier 120 is in a normal state. The “no task” indicates that the autonomous carrier 120 does not have a task such as carrying a shelf. The “with task” indicates that the autonomous carrier 120 has a task. The “charging” indicates that the autonomous carrier 120 is charging.

The carrying shelf 803 indicates whether each autonomous carrier 120 is carrying the shelf 110. Since the autonomous carrier 120 whose the state 802 is “no task” or “charging” is not carrying the shelf 110, the carrying shelf 803 corresponding to the autonomous carrier 120 may be blank. When the autonomous carrier 120 whose the state 802 is “with task” is carrying the shelf 110 for the task, the carrying shelf 803 corresponding to the autonomous carrier 120 is “Yes”. On the other hand, even if the state 802 is “with task”, for example, the carrying shelf 803 of the autonomous carrier 120 moving toward the node where the shelf to be carried is placed in the task is “No”.

The current position 804 indicates the current location of each autonomous carrier 120. The current position 804 may be, for example, a node number.

The direction 805 indicates the direction in which each autonomous carrier 120 is currently facing. For example, the direction 805 may indicate the direction in which the front of each autonomous carrier 120 is currently facing.

In the present example, the values of the current position 804 and the direction 805 of the autonomous carrier 120 whose the state 802 is other than “error” are treated as correct. On the other hand, the values of the current position 804 and the direction 805 of the autonomous carrier 120 whose the state 802 is “error” may be incorrect (that is, the autonomous carrier is actually placed at a different location or facing a different direction).

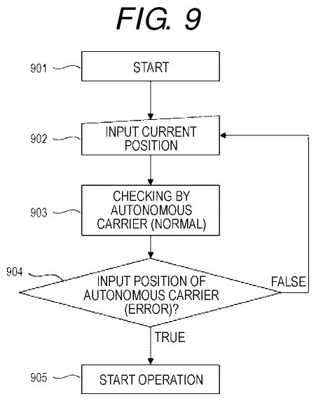

FIG. 9 is a flowchart illustrating processing executed when an error has occurred in the autonomous carrier 120 in the warehouse to which Example 1 of the present invention is applied.

When an error occurs in the autonomous carrier 120, processing of checking the position of the autonomous carrier 120 starts (step 901). Here, the autonomous carrier 120 in which the error has occurred is an autonomous carrier 120 that does not have reliable self-position information.

For example, the autonomous carrier 120 stops at one of the nodes due to a failure, and after the autonomous carrier 120 is manually removed from the warehouse, repaired, and placed back at any node in the warehouse after being recovered from the failure, the node at which the autonomous carrier 120 is placed at the time of the failure and the node at which the autonomous carrier 120 is placed after the recovery are not necessarily the same, and even if the same, the recovered autonomous carrier 120 does not always store the node that was located at the time of the failure. When the autonomous carrier 120 comes into contact with some obstacle and is moved manually to a place where the movement can be restarted, the autonomous carrier 120 restarts from a place different from the node where the failure occurred. Therefore, for such an autonomous carrier 120, the current position 804 and the direction 806 of the carrier information 323 stored by the overall control system 100 may not be accurate.

In the following processing, the above-described autonomous carrier 120 is treated as the autonomous carrier 120 in which an error has occurred. Here, as illustrated in FIG. 2, the autonomous carrier 120 in which an error has occurred is referred to as an autonomous carrier (error) 120A, and the normal autonomous carrier 120 is referred to as an autonomous carrier (normal) 120B.

Next, the operator 140 inputs the current location of the autonomous carrier (error) 120A to the input terminal 130 (step 902). Here, the current location is, for example, when the autonomous carrier (error) 120A recovers from a failure and is placed at any node, the number of that node. Next, the autonomous carrier (normal) 120B checks the existence of the autonomous carrier (error) 120A (step 903).

Next, the overall control system 100 determines whether the current location input in step 902 is correct based on the result of the check in step 903 (step 904). If it is determined that the input current location is incorrect, the processing after step 902 is executed again. If it is determined that the input current location is correct, the processing of checking the position of the autonomous carrier (error) 120A ends, and the autonomous carrier (error) 120A starts operating as the normal autonomous carrier 120 (step 905).

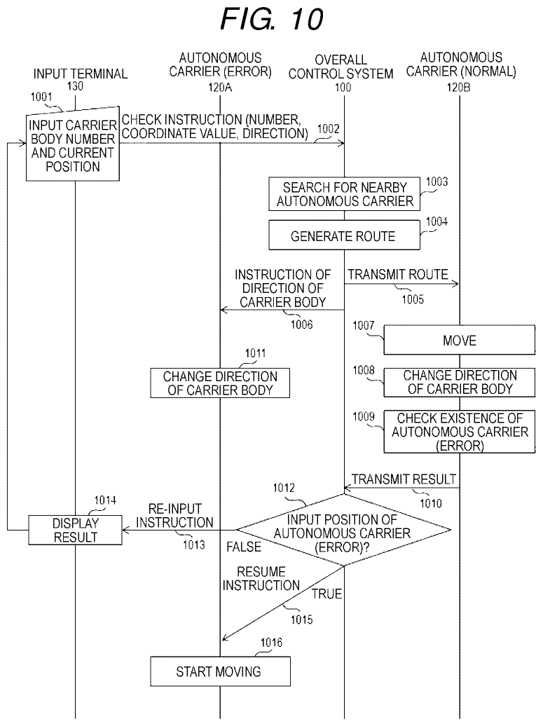

FIG. 10 is a sequence diagram illustrating processing in which the normal autonomous carrier 120 checks an autonomous carrier 120 in which an error has occurred in the warehouse to which Example 1 of the present invention is applied.

Specifically, FIG. 10 describes the processing illustrated in FIG. 9 in detail. First, the operator 140 inputs the carrier number for identifying the autonomous carrier (error) 120A, the current location (current position) and the orientation of the autonomous carrier (error) 120A to the input terminal 130 (step 1001). This processing corresponds to step 902 in FIG. 9. The input terminal 130 generates a check instruction based on the input information and transmits the instruction to the overall control system 100 (step 1002). This check instruction includes, for example, the input carrier number, current location, and direction.

Upon receiving the check instruction, the overall control system 100 searches for a normal autonomous carrier 120 near the autonomous carrier (error) 120A (step 1003). Specifically, the nearby autonomous carrier search unit 317 (FIG. 3) of the overall control system 100 refers to the carrier information 323 (FIG. 8) and selects any normal autonomous carrier 120 (that is, an autonomous carrier 120 other than the autonomous carrier (error) 120A, of which a reliable position and a direction are stored in the carrier information 323) as the autonomous carrier (normal) 120B to check the autonomous carrier (error) 120A.

The method of this selection is not limited, but to name a few representative methods, for example, the autonomous carrier 120 closest to the input current location of the autonomous carrier (error) 120A may be selected, an autonomous carrier 120 with no tasks may be selected, or an autonomous carrier 120 with a task that is scheduled to travel near the current location of the autonomous carrier (error) 120A for execution of the task may be selected.

Next, the overall control system 100 generates a route for moving the autonomous carrier (normal) 120B to a position where the existence of the autonomous carrier (error) 120A is checked (step 1004). Specifically, the route generation unit 318 (FIG. 3) of the overall control system 100 refers to the carrier information 323 (FIG. 8) and the in-warehouse map 321 (FIG. 4) to generate a route starting from the current position of the autonomous carrier (normal) 120B and ending at a position where the existence of the autonomous carrier (error) 120A is checked.

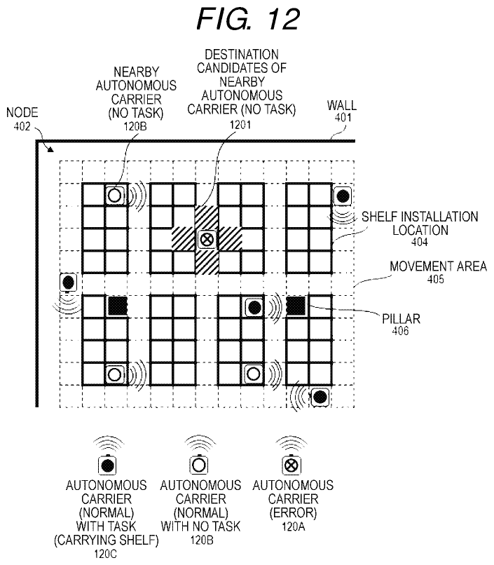

Here, the position at which the existence of the autonomous carrier (error) 120A is checked may be any position as long as the position at which the existence check using the sensor 346 described below can be executed. For example, a position where the relationship with the current location satisfies a predetermined condition may be such that the distance from the current location of the autonomous carrier (error) 120A input in step 1001 is within a predetermined range and no obstacle exists before the current location. In the present example, as an example of such a position, a node adjacent to the current node of the autonomous carrier (error) 120A input in step 1001 is set as the end point of the route (see FIG. 12).

The overall control system 100 transmits the route generated in step 1004 to the autonomous carrier (normal) 120B (step 1005). For example, the overall control system 100 may move the generated route and transmit an instruction to check the existence of the autonomous carrier (error) 120A at the destination to the autonomous carrier (normal) 120B. If it is necessary to change the direction of the autonomous carrier (normal) 120B at the destination in order to check the existence of the autonomous carrier (error) 120A, an instruction on the direction of the carrier body for making the change is included. The overall control system 100 transmits an instruction on the direction of the carrier body to the autonomous carrier (error) 120A (step 1006).

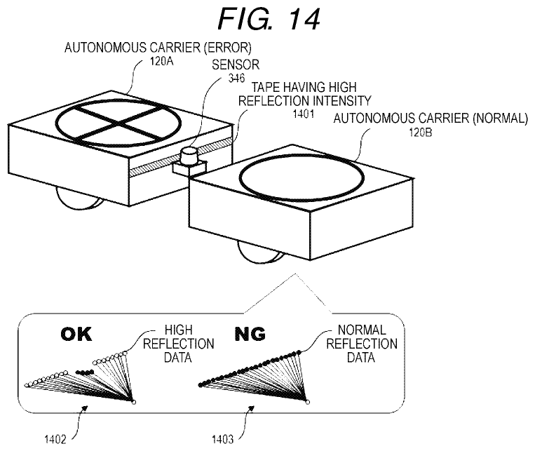

Specifically, based on the relationship between the current location and direction of the autonomous carrier (error) 120A input in step 1001 and the position of the end point of the route generated in step 1004, the carrier body direction instruction unit 319 (FIG. 3) of the overall control system 100 may determine whether the current direction in which the both carriers are facing is the direction to be directed to perform the existence check. The direction to be directed to perform the existence check is, for example, a direction in which surfaces on which both sensors 346 are installed face each other, as described later with reference to FIG. 14.

Then, when the both sensors 346 are facing in directions other than the direction in which the both are to face, the carrier body direction instruction unit 319 may determine a direction of the both sensors 346 so that the both sensors 346 face in the direction that the both are to face and transmit an instruction to face the direction.

The autonomous carrier (error) 120A changes the direction of the carrier body according to the received instruction of the direction of the carrier body (step 1011).

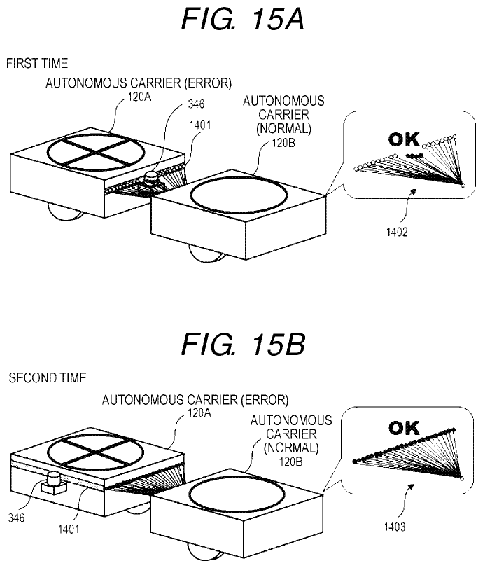

The autonomous carrier (normal) 120B moves along the received route (step 1007) to change the direction of the carrier body to check the existence of the autonomous carrier (error) 120A (step 1008). For example, the autonomous carrier (normal) 120B may change the direction of the carrier body so that the surface of the carrier body on which the sensor 346 is installed faces the direction of the node input as the current location of the autonomous carrier (normal) 120B. Then, the autonomous carrier (normal) 120B checks the existence of the autonomous carrier (error) 120A by the measurement of the sensor 346 (step 1009) and transmits the result to the overall control system 100 (step 1010). An example of a specific method of the existence check will be described later (see FIGS. 14 and 15).

Based on the result of the existence check transmitted from the autonomous carrier (normal) 120B, the normal/error check unit 320 of the overall control system 100 determines whether the current location and the direction input in step 1001 are correct, that is, whether the autonomous carrier (error) 120A is actually placed at the current location input in step 1001 and faces the input direction (step 1012).

When it is determined that the input current location and direction are incorrect, the overall control system 100 transmits a resume instruction to the input terminal 130 (step 1013). The input terminal 130 that has received the resume instruction displays a result indicating that the input current location and direction are incorrect (step 1014). Thereafter, the processing returns to step 1001, and the operator again inputs the position and the like of the autonomous carrier (error) 120A to the input terminal 130.

On the other hand, when it is determined that the input current location is correct, the overall control system 100 transmits a resume instruction to the autonomous carrier (error) 120A (step 1015). The autonomous carrier (error) 120A that has received the resume instruction starts moving as a normal autonomous carrier 120 (step 1016).

As described above, the selection of the autonomous carrier (normal) 120B to perform the existence check, the creation of the movement route of the autonomous carrier (normal) 120B, the change of the direction of each autonomous carrier 120, the measurement of the sensor, and the like are automatically performed, thereby reducing the burden on the operator 140.

Here, an example of a screen displayed by the input terminal 130 in step 1001 will be described.

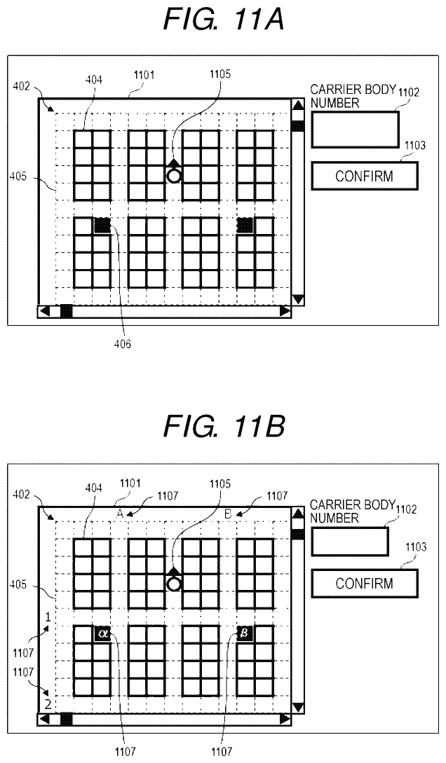

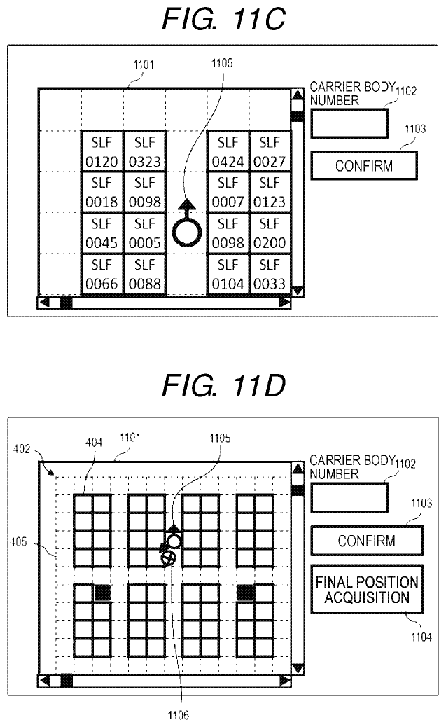

FIGS. 11A to 11D are explanatory diagrams of examples of screens displayed by the output device 333 of the input terminal 130 according to Example 1 of the present invention.

The screen illustrated in FIG. 11A includes a position/direction input area 1101, a carrier body number input area 1102, and a confirm button 1103. In the position/direction input area 1101, a plan view of at least a part of the warehouse (for example, an area including the position of the autonomous carrier (error) 120A) is displayed. In the example of FIG. 11A, the node 402 in the warehouse is displayed as a solid line or broken line grid, and the pillar 406 is displayed as a black solid square. Among the nodes 402, the movement area 405 is displayed as a thin broken line grid, and the shelf installation location 404 is displayed as a thick solid line grid.

The operator 140 operates the input device 232 to input the position and direction of the autonomous carrier (error) 120A in the displayed plan view and inputs the carrier number of the autonomous carrier (error) 120A in the carrier body number input area 1102. For example, a symbol 1105 indicating the input position and direction of the autonomous carrier (error) 120A includes a circle indicating the position and an arrow indicating the direction (for example, the direction in which the front of the autonomous carrier (error) 120A is facing). Then, when the operator 140 operates the confirm button 1103, the input information is transmitted to the overall control system 100 (step 1002 in FIG. 10). This facilitates input of the position and direction of the autonomous carrier (error) 120A by the operator 140.

The screen illustrated in FIG. 11B includes the position/direction input area 1101, the carrier body number input area 1102, and the confirm button 1103, as in the example of FIG. 11A. However, in the example of FIG. 11B, a sign including information (for example, a character or a symbol) for identifying a position is installed in an actual space in the warehouse. For example, paper or the like on which a unique character or symbol is printed is installed as a sign on a plurality of places such as walls or pillars in the warehouse. Then, in the position/direction input area 1101, on the plan view, at a position corresponding to the place where each sign is installed, a character or numeral 1107 as the contents of the sign is displayed.

The operator 140 inputs the position where the autonomous carrier (error) 120A is placed on the plan view based on the relationship between the position of the sign installed in the actual space in the warehouse and the position where the autonomous carrier (error) 120A is actually placed, and the position of the sign displayed in the plan view of the position/direction input area 1101. By using the sign in this way, the operator 140 can easily input the position of the autonomous carrier (error) 120A, thereby preventing erroneous input.

The screen illustrated in FIG. 11C includes the position/direction input area 1101, the carrier body number input area 1102, and the confirm button 1103, as in the example of FIG. 11A. However, in the example of FIG. 11C, information (for example, the shelf ID 701 illustrated in FIG. 7) for identifying each shelf 110 is displayed on each actual shelf 110 in the warehouse. Then, information (for example, “SLF0120” or the like) for identifying each shelf 110 is displayed at a position corresponding to the node 402 where each shelf 110 is placed on the plan view in the position/direction input area 1101.

The operator 140 refers to the identification information displayed on the shelf 110 near the position where the autonomous carrier (error) 120A is actually placed and the identification information of the shelf 110 displayed in the plan view of the position/direction input area 1101 to input the position where the autonomous carrier (error) 120A is placed on the plan view. By using the display of the identification information in this way, the operator 140 can easily input the position of the autonomous carrier (error) 120A, thereby preventing erroneous input.

The screen illustrated in FIG. 11D includes a final position acquisition button 1104 in addition to the position/direction input area 1101, the carrier body number input area 1102, and the confirm button 1103 similar to those in the example of FIG. 11A. When the operator 140 inputs the carrier body number of the autonomous carrier (error) 120A to the carrier body number input area 1102 and operates the final position acquisition button 1104 before inputting the position and direction of the autonomous carrier (error) 120A, the latest one (hereinafter, referred to as a final stop position) of the positions of the autonomous carrier (error) 120A acquired at the time of stopping due to the occurrence of an error is displayed on the plan view of the position/direction input area 1101.

This final stop position is acquired by the overall control system 100 from the autonomous carrier (error) 120A and transmitted to the input terminal 130. For example, each autonomous carrier 120 may periodically transmit the result of self-position estimation to the overall control system. 100, and the overall control system 100 may use the position last received from the autonomous carrier (error) 120A as the final stop position.

In the example of FIG. 11D, a circular symbol 1106 on which an X mark is superimposed indicates the final stop position of the autonomous carrier (error) 120A. The operator 140 refers to the displayed final stop position, inputs the current position of the autonomous carrier (error) 120A, and operates the confirm button 1103.

In some cases, the amount of movement from the position where the autonomous carrier (error) 120A stops to the position where the use is restarted may be small. For example, the autonomous carrier 120 collides with the legs of the shelf 110 and stops, resulting in an error state, thereafter, the operator 140 moves the autonomous carrier 120 to the node 402 near (for example, closest to) the stop position and resumes use. In such a case, displaying the final stop position facilitates the input of the position of the autonomous carrier (error) 120A by the operator 140, thereby preventing erroneous input.

In order to realize the above processing, when the autonomous carrier (error) 120A stops due to an error, the autonomous carrier (error) 120A stores the self-position acquired by the self-position estimation unit 348 at that time and transmits the self-position to the overall control system 100. It is desirable that the self-position is not the number of the node 402 where the autonomous carrier (error) 120A is located, but a coordinate value with higher resolution.

At this time, the autonomous carrier (error) 120A may transmit not only the latest self-position but also the self-position acquired during a predetermined period before the autonomous carrier (error) 120A stops to the overall control system 100. In that case, the input terminal 130 can acquire the self-position from the overall control system 100 and display the trajectory until the autonomous carrier (error) 120A stops in the position direction input area 1101.

The input terminal 130 may automatically acquire and display the final stop position from the overall control system 100 without operating the final position acquisition button 1104 by the operator 140. In that case, the display of the final position acquisition button 1104 is unnecessary.

Next, the search for a nearby autonomous carrier and the generation of a route (steps 1003 and 1004 in FIG. 10) executed by the overall control system 100 will be described.

FIG. 12 is an explanatory diagram of destination candidates in route generation by the overall control system 100 according to Example 1 of the present invention.

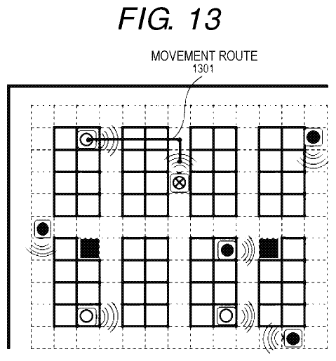

FIG. 12 illustrates a plan view of a partial area of the warehouse. There are a plurality of autonomous carriers 120 in this area, and one thereof has an error. In the example of FIG. 12, the autonomous carrier 120 in which an error has occurred is referred to as an autonomous carrier (error) 120A. On the other hand, among the normal autonomous carriers, those with no tasks are described as autonomous carriers (normal/no task) 120B, and those with tasks are described as autonomous carriers (normal/with task) 120C. In this example, it is assumed that the autonomous carrier (normal/with task) 120C is carrying shelves. The same applies to the example of FIG. 13 described later.

The node on which the autonomous carrier (error) 120A is displayed in FIG. 12 is the node input as the current location of the autonomous carrier (error) 120A in step 1001 in FIG. 10, and if the input is incorrect, the autonomous carrier (error) 120A is actually placed at another node. On the other hand, the nodes on which the autonomous carrier (normal/no task) 120B and the autonomous carrier (normal/task equipped) 120C are displayed are the nodes where the carriers are actually placed.

As described with reference to FIG. 10, in step 1003, the overall control system 100 selects one of the normal autonomous carriers 120 as an autonomous carrier to perform the existence check of the autonomous carriers (error) 120A. Then, in step 1004, the overall control system 100 generates a movement route from the node at the current location of the selected autonomous carrier 120 to the node for checking the existence of the autonomous carrier (error) 120A.

Here, a node that can be a node for checking the existence of the autonomous carrier (error) 120A is described as a destination candidate. Actually, even if the node is not adjacent to the node input as the current location of the autonomous carrier (error) 120A, as long as there is no obstacle between the node and the node input as the current location of the autonomous carrier (error) 120A, the node can be a node for checking the existence of the autonomous carrier (error) 120A, but here, for ease of description, nodes other than the four nodes adjacent to the node input as the current location of the autonomous carrier (error) 120A are excluded from the destination candidates.

In the example of FIG. 12, the node input as the current location of the autonomous carrier (error) 120A is the node of the movement area 405 sandwiched between the two shelf installation locations 404. Therefore, among the four nodes adjacent to the node input as the current location of the autonomous carrier (error) 120A, two nodes belong to the shelf installation location 404, and the remaining two nodes belong to the moving area 405.

The autonomous carrier 120 that is not carrying a shelf can move to any node of the shelf installation location 404 and the movement area 405 as long as there is no other autonomous carrier 120. Therefore, in step 1003 of FIG. 10, when any one of the autonomous carriers (normal/no task) 120B is selected as a nearby autonomous carrier to perform the existence check of the autonomous carrier (error) 120A, the destination candidates of the selected autonomous carrier (normal/no task) 120B are four nodes adjacent to four sides of the node input as the current location of the autonomous carrier (error) 120A. FIG. 12 illustrates an example in which four hatched nodes are destination candidates 1201 of the nearby autonomous carrier (normal/no task) 120B selected as a nearby autonomous carrier.

On the other hand, the autonomous carrier 120 carrying a shelf can move to the node in the movement area 405 as long as there is no other autonomous carrier 120, but cannot move to the node at the shelf installation location 404 (that is, the other shelf 110 is located). Therefore, in step 1003 of FIG. 10, when any one of the autonomous carriers (normal/with task) 120C is selected as a nearby autonomous carrier to perform the existence check of the autonomous carrier (error) 120A, the destination candidate of the selected autonomous carrier (normal/with task) 120C is a node belonging to the movement area 405 among the four nodes adjacent to the four sides of the node input as the current location of the autonomous carrier (error) 120A.

When the autonomous carrier (error) 120A is adjacent to an area where the autonomous carrier 120 cannot move regardless of the presence of the task, for example, the wall 401 or the pillar 406, the area is excluded from the destination candidates.

FIG. 13 is an explanatory diagram of a movement route generated by the overall control system 100 according to Example 1 of the present invention.

In step 1004 (FIG. 10), the route generation unit 318 of the overall control system 100 generates a movement route from the current location of the autonomous carrier 120 selected by the nearby autonomous carrier search unit 317 to any of the destination candidate nodes. When the autonomous carrier (normal/no task) 120B is selected, since the autonomous carrier (normal/no task) 120B can pass under the shelf, the route generation unit 318 can generate a movement route 1301 including a node belonging to the shelf installation location 404 as illustrated in FIG. 13. On the other hand, when the autonomous carrier (normal/with task) 120C is selected, since the autonomous carrier (normal/with task) 120C cannot pass under the shelf, the route generation unit 318 generates a movement route that does not include a node belonging to the shelf installation location 404. Thereby, a movement route suitable for the state of the autonomous carrier 120 is generated.

Next, the existence check processing executed in step 1009 of FIG. 10 will be described.

FIG. 14 is an explanatory diagram of an example of the existence check of the autonomous carrier 120 executed by the autonomous carrier 120 and the overall control system 100 according to Example 1 of the present invention.

In the example of FIG. 14, the autonomous carrier (error) 120A is actually placed at the current location input in step 1001 of FIG. 10. Step 1011 of the autonomous carrier (error) 120A and step 1008 of the autonomous carrier (normal) 120B have been completed. Therefore, the autonomous carrier (normal) 120B is located at a node adjacent to the node where the autonomous carrier (error) 120A is placed, and the front thereof faces the node where the autonomous carrier (error) 120A is placed. The front of the autonomous carrier (error) 120A faces the node where the autonomous carrier (normal) 120B is placed.

In the example of FIG. 14, the sensor 346 is installed in front of each autonomous carrier 120 including the autonomous carrier (error) 120A and the autonomous carrier (normal) 120B. The sensor 346 in this example is a laser distance sensor, and is installed so as to protrude in front of each autonomous carrier 120. A tape 1401 having high reflection intensity is attached to the front of each autonomous carrier 120 at the same height as the sensing surface of the sensor 346.

If the sensor 346 is a laser distance sensor, the distance from the sensor 346 to the target existing in the sensing plane (for example, in the horizontal plane including the mounting position of the sensor 346) and the reflection intensity of the laser light from the object can be measured by using the sensor 346.

As illustrated in FIG. 14, in a case where the front of the autonomous carrier (error) 120A and the front of the autonomous carrier (normal) 120B face each other, when the measurement by the sensor 346 of the autonomous carrier (normal) 120B is performed, the sensor data acquisition unit 350 of the autonomous carrier (normal) 120B acquires data 1402 indicating a distance to each point on the front of the autonomous carrier (error) 120A and a reflection intensity. The data 1402 includes the shape of the sensor 346 installed in front of the autonomous carrier (error) 120A and the high reflection intensity due to the tape 1401.

In step 1009 (FIG. 10), the autonomous carrier existence check unit 351 (FIG. 3) of the autonomous carrier (normal) 120B compares the shape and reflection intensity of the object specified from the acquired data 1402 with the carrier body shape data 355. In this example, as the carrier body shape data 355, data indicating the front shape and the reflection intensity of the autonomous carrier 120 is stored. By comparing the carrier body shape data 355 with the acquired data 1402, the autonomous carrier existence check unit 351 can determine that there is another autonomous carrier 120 at a node adjacent to the node where the autonomous carrier (normal) 120B is placed and that the front faces the autonomous carrier (normal) 120B.

On the other hand, if the position of the autonomous carrier (error) 120A is correct but the direction is incorrect, as a result of the measurement by the sensor 346 of the autonomous carrier (normal) 120B, data 1403 with a low reflection intensity that does not include the shape of the sensor 346 is acquired. In this case, by comparing the carrier body shape data 355 with the acquired data 1403, the autonomous carrier existence check unit 351 can determine that there is another autonomous carrier 120 at a node adjacent to the autonomous carrier (normal) 120B, but the front is not facing the direction of the autonomous carrier (normal) 120B.

If the autonomous carrier (error) 120A is not placed at a node adjacent to the node where the autonomous carrier (normal) 120B is placed, the autonomous carrier existence check unit 351 can determine that there is no autonomous carrier 120 at the adjacent node based on the distance to the object measured by the sensor 346.

The autonomous carrier (normal) 120B transmits the result of the above determination to the overall control system 100 (step 1010 in FIG. 10). If it is determined that there is another autonomous carrier 120 at a node adjacent to the autonomous carrier (normal) 120B and that the front is facing the direction of the autonomous carrier (normal) 120B, the normal/error check unit 320 of the overall control system 100 determines that the position and direction of the autonomous carrier (error) 120A stored by the overall control system 100 are correct, that is, the position and direction of the autonomous carrier (error) 120A input in step 1001 are correct (step 1012).

As described above, when it is determined that there is another autonomous carrier 120 at a node adjacent to the autonomous carrier (normal) 120B, but the front is not facing the direction of the autonomous carrier (normal) 120B, the autonomous carrier (normal) 120B may transmit the result of the determination to the overall control system 100 in step 1010. In that case, the overall control system 100 may determine that the position of the autonomous carrier (error) 120A input in step 1001 is correct, but the direction is incorrect, or the autonomous carrier 120 at the adjacent node is an autonomous carrier 120 other than the autonomous carrier (error) 120A to be checked (that is, the position of the autonomous carrier (error) 120A input in step 1001 is incorrect) and transmit the result of the determination to the input terminal 130 (step 1013). The input terminal 130 displays the result of the determination in step 1014.

In the example of FIG. 14, the directions of the autonomous carrier (error) 120A and the front of the autonomous carrier (normal) 120B are controlled so that the both autonomous carriers face each other, and in this state, measurement by the sensor 346 of the autonomous carrier (normal) 120B is performed. The reason why the front of the autonomous carrier (normal) 120B is directed toward the autonomous carrier (error) 120A is that the sensor 346 of the autonomous carrier (normal) 120B is installed only on the front. Therefore, if the autonomous carrier (normal) 120B includes a plurality of sensors 346 installed on different surfaces, measurement can be performed by directing one of these surfaces to the autonomous carrier (error) 120A. For example, when the autonomous carrier (normal) 120B includes the sensors 346 on all surfaces, it is not necessary to change the direction of the autonomous carrier (normal) 120B in step 1008 for measurement. The same applies to the case where the sensor 346 can measure all directions.

On the other hand, the reason to direct the front of the autonomous carrier (error) 120A toward the autonomous carrier (normal) 120B is because the sensor 346 of the autonomous carrier (error) 120A is installed only on the front surface, and the shape of the front surface is different from the shape of other surfaces. By detecting the shape of the front, it is possible to determine whether the direction of the autonomous carrier (error) 120A is correct. However, when the surface other than the front surface has a shape different enough to be distinguished from the other surfaces, the surface other than the front surface may be directed to the autonomous carrier (normal) 120B.

For example, regardless of the presence of the sensor 346, when the shape of each surface of the autonomous carrier (error) 120A is different enough to be identified with sufficient accuracy by measurement using the sensor 346, any surface of the autonomous carrier (error) 120A may be directed to the autonomous carrier (normal) 120B. In that case, it is not necessary to change the direction of the carrier body in step 1011. When the carrier body shape data 355 of the autonomous carrier (normal) 120B includes the shape data of each surface, and the autonomous carrier (normal) 120B compares the shape acquired by the measurement with the carrier body shape data 355, it is possible to specify which side of the autonomous carrier (error) 120A faces the autonomous carrier (normal) 120B.

In the example of FIG. 14, the tape 1401 is affixed on one of the surfaces to ensure the identification of the surface by providing a portion having a different reflection intensity from the other surfaces. Therefore, portions having different reflection intensities may be provided for each surface by a method other than affixing a tape, for example, by applying coating materials having different reflection intensities or using members having different reflection intensities for the exterior. Different patterns may be drawn on each surface with tapes having different reflection intensities. For example, when it is possible to identify a surface with sufficiently high accuracy based only on the shape, it is not necessary to provide portions having different reflection intensities.

As illustrated in FIG. 14, when the autonomous carrier 120 exists at the input position by the measurement of the sensor 346, and the direction is the same as the direction obtained by adding the change in step 1011 to the input direction, it is estimated that the autonomous carrier 120 is the autonomous carrier (error) 120A, that is, the position and direction input in step 1001 are correct. However, for example, when there are a plurality of autonomous carriers 120 for which the overall control system 100 does not know the position and direction, the above estimation may be incorrect. For example, even if it is determined that in step 1009, there is another autonomous carrier 120 at a node adjacent to the node where the autonomous carrier (normal) 120B is placed, and the front faces toward the autonomous carrier (normal) 120B, the other autonomous carrier 120 may be an autonomous carrier 120 different from the autonomous carrier (error) 120A to be checked. The existence check method executed to prevent such erroneous check will be described below.

FIG. 15 is an explanatory diagram of another example of the existence check of the autonomous carrier 120 executed by the autonomous carrier 120 and the overall control system 100 according to Example 1 of the present invention.

In this example, in step 1009, a first time of existence check illustrated in FIG. 15A and a second time of existence check illustrated in FIG. 15B are performed. Since the first time of existence check is the same as that illustrated in FIG. 14, the description is omitted. As a result of the first time of existence check, when it is determined that there is another autonomous carrier 120 at a node adjacent to the node where the autonomous carrier (normal) 120B is placed, and the front faces the direction of the autonomous carrier (normal) 120B, the second time of existence check is performed.

In the second time of existence check, first, the overall control system 100 instructs the autonomous carrier (error) 120A to change the direction of the carrier body. For example, when an instruction to change the direction of the carrier body by 90° is transmitted, the autonomous carrier (error) 120A changes the direction of the carrier body by 90° according to the instruction. Then, the autonomous carrier (normal) 120B executes the measurement by the sensor 346 again.

When the other autonomous carrier 120 whose existence is checked by the first time of existence check is the same as the autonomous carrier (error) 120A to be checked, the direction of the body of the other autonomous carrier 120 has been changed, and the data 1403 is acquired in the second time of existence check. As a result, it is confirmed that the other autonomous carrier 120 whose existence has been checked by the first time of existence check is the autonomous carrier (error) 120A to be checked. The autonomous carrier (normal) 120B transmits these results to the overall control system 100 (step 1010 in FIG. 10). Based on the received results, the normal/error check unit 320 of the overall control system 100 determines that the position and direction of the autonomous carrier (error) 120A input in step 1001 are correct (step 1012).

On the other hand, if the other autonomous carrier 120 whose existence has been checked by the first time of existence check is not the autonomous carrier (error) 120A to be checked, since the direction of the carrier body of the other autonomous carrier 120 has not been changed, the data 1402 is acquired in the second time of existence check in the same manner as in the first time. As a result, it is confirmed that the other autonomous carrier 120 whose existence has been checked by the first time of existence check is not the autonomous carrier (error) 120A to be checked. The autonomous carrier (normal) 120B transmits these results to the overall control system 100 (step 1010 in FIG. 10). Based on the received result, the normal/error check unit 320 of the overall control system 100 determines that the position and direction of the autonomous carrier (error) 120A input in step 1001 are incorrect (step 1012).

In the above example, the front of the autonomous carrier (error) 120A is measured first, and then the other surfaces are measured, but the order of the measurements may be reversed. As described with reference to FIG. 14, when each surface has a unique shape regardless of the presence of the sensor 346, the front measurement need not be performed. In the above example, the rotation is performed by 90°, but the rotation may be performed at another angle (for example, 180°).

According to Example 1 of the present invention, even in a warehouse where a marker or the like for the autonomous carrier 120 to read to estimate the self-position is not installed, when the position of the carrier is changed after a stop and the stop position and the restart position are different, the autonomous carrier 120 can restart the autonomous movement without returning to the predetermined return position. Since the movement is started after checking that the position input by the operator 140 is correct, it is possible to prevent the occurrence of accidents and errors due to input errors. The processing is automatically executed when the operator 140 inputs the position of the autonomous carrier 120, thereby reducing the burden on the operator.

### Example 2

Next, Example 2 of the present invention will be described. Except for the differences described below, each unit of the system of Example 2 has the same functions as each unit denoted by the same reference numerals of Example 1 illustrated in FIGS. 1 to 7, and description thereof is omitted.

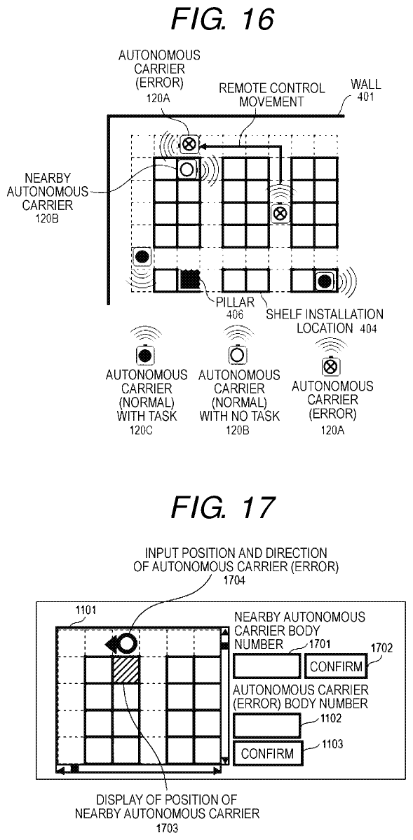

FIG. 16 is an explanatory diagram of an example of the existence check of the autonomous carrier 120 executed by the autonomous carrier 120 and the overall control system 100 according to Example 2 of the present invention.

In Example 1, the autonomous carrier (normal) 120B moves to the vicinity of the autonomous carrier (error) 120A (for example, an adjacent node) and checks the existence of the autonomous carrier (error) 120A. On the other hand, in Example 2, the autonomous carrier (error) 120A moves to the vicinity of any of the autonomous carriers (normal) 120B, and the autonomous carrier (normal) 120B checks the existence.

In the example of FIG. 16, the operator 140 moves the autonomous carrier (error) 120A to a node adjacent to any of the autonomous carriers (normal/no task) 120B by, for example, remote control. Next, the operator 140 inputs the carrier number for identifying the autonomous carrier (normal/no task) 120B (hereinafter, also referred to as a nearby autonomous carrier (normal/no task) 120B) to the input terminal 130. The carrier number is displayed on each autonomous carrier 120, for example, so that the operator 140 can read the carrier number visually.

When the operator 140 further inputs the position and direction of the moved autonomous carrier (error) 120A to the input terminal 130, the existence of the autonomous carrier (error) 120A is checked by the nearby autonomous carrier (normal/no task) 120B.

FIG. 17 is an explanatory diagram of an example of a screen displayed by the output device 333 of the input terminal 130 according to Example 2 of the present invention.

In the output device 333 of the input terminal 130 according to Example 2, in addition to the same position/direction input area 1101, the carrier body number input area 1102, and the confirm button 1103 as in Example 1, a nearby autonomous carrier body number input area 1701 and a confirm button 1702 are displayed. As described with reference to FIG. 16, when the autonomous carrier (error) 120A moves to a node adjacent to the nearby autonomous carrier (normal/no task) 120B, the operator 140 inputs a carrier number for identifying the nearby autonomous carrier (normal/no task) 120B to the nearby autonomous carrier body number input area 1701 and operates the confirm button 1702.

As a result, in the position/direction input area 1101, a plan view of an area including at least the node where the nearby autonomous carrier (normal/no task) 120B is placed in the warehouse is displayed. A position (for example, a node) 1703 where the nearby autonomous carrier (normal/no task) 120B is placed is displayed on the plan view. The operator 140 refers to the display and inputs the position and direction 1704 of the moved autonomous carrier (error) 120A in the position/direction input area 1101.

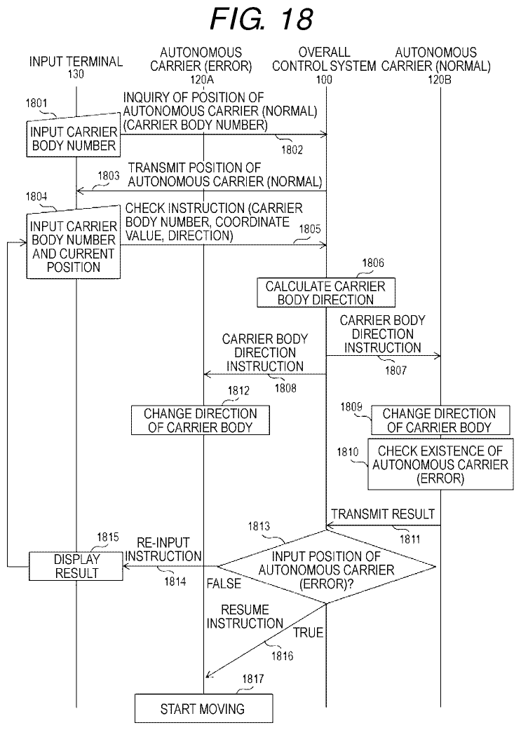

FIG. 18 is a sequence diagram illustrating processing in which a normal autonomous carrier 120 checks an autonomous carrier 120 in which an error has occurred in the warehouse to which Example 2 of the present invention is applied.

First, the operator 140 moves the autonomous carrier (error) 120A to a vicinity (for example, an adjacent node) of one of the autonomous carriers (normal) 120B by operating, for example, a remote control. Then, the operator 140 inputs the carrier number for identifying the autonomous carrier (normal) 120B to the input terminal 130 (step 1801).

The autonomous carrier (normal) 120B described here corresponds to the nearby autonomous carrier (normal/no task) 120B in the examples of FIGS. 16 and 17, but generally, either the autonomous carrier (normal/no task) 120B or the autonomous carrier (normal/with task) 120C may be used.

The input terminal 130 generates an autonomous carrier (normal) position inquiry based on the input information and transmits the generated inquiry to the overall control system 100 (step 1802). This check instruction includes the input carrier number. The overall control system 100 refers to the carrier information 323, specifies the position of the autonomous carrier (normal) 120B identified by the carrier number included in the received check instruction, and transmits the specified position to the input terminal 130 (step 1803).

The input terminal 130 displays the position of the received autonomous carrier (normal) 120B on the output device 333 (see FIG. 17). Specifically, for example, as illustrated in FIG. 17, the input terminal 130 may display the position of the specified autonomous carrier (normal) 120B on a map of an area including the position of the specified autonomous carrier (normal) 120B.

The operator 140 inputs the carrier number for identifying the autonomous carrier (error) 120A and the current location and direction of the autonomous carrier (error) 120A with reference to the displayed position (step 1804). The input terminal 130 generates a check instruction based on the input information and transmits the instruction to the overall control system 100 (step 1805). This check instruction includes, for example, the input carrier number, current location, and direction.

Upon receiving the check instruction, the overall control system 100 calculates the current directions of the autonomous carrier (error) 120A and the autonomous carrier (normal) 120B with reference to the carrier information 323 and the received check instruction (step 1806). If the relationship between the current directions of the both carriers is not a predetermined relationship to check the existence of the autonomous carrier (error) 120A by the autonomous carrier (normal) 120B (for example, the relationship where the fronts of both faces each other), the overall control system 100 generates and transmits an instruction for the direction of the carrier body so that the relationship is established (steps 1807 and 1808). The autonomous carrier (normal) 120B and the autonomous carrier (error) 120A change the direction of the carrier body according to the received instruction (steps 1809 and 1812).

Next, the autonomous carrier (normal) 120B checks the existence of the autonomous carrier (error) 120A (step 1810) and transmits the result to the overall control system 100 (step 1811). The specific method of the existence check may be the same as that of Example 1, and thus the description is omitted.

Based on the result of the existence check transmitted from the autonomous carrier (normal) 120B, the normal/error check unit 320 of the overall control system 100 determines whether the current location input in step 1804 is correct (Step 1813).

When it is determined that the input current location is incorrect, the overall control system 100 transmits a resume instruction to the input terminal 130 (step 1814). The input terminal 130 that has received the resume instruction displays a result indicating that the input current location is incorrect (step 1815). Thereafter, the processing returns to step 1804, and the operator 140 inputs the position and the like of the autonomous carrier (error) 120A to the input terminal 130 again.

On the other hand, when it is determined that the input current location is correct, the overall control system 100 transmits a resume instruction to the autonomous carrier (error) 120A (step 1816). The autonomous carrier (error) 120A that has received the resume instruction starts moving as a normal autonomous carrier 120 (step 1817).

According to the above-described Example 2 of the present invention, instead of moving the normal autonomous carrier 120, the autonomous carrier 120 in which an error has occurred can be moved, and the position of the autonomous carrier 120 in which the error has occurred can be checked. For example, if a normal autonomous carrier 120 exists near the place where the autonomous carrier 120 in which an error has occurred has returned from a failure or the like, by the above procedure, the position and the like of the autonomous carrier 120 in which the error has occurred can be quickly confirmed.

The present invention is not limited to the above-described examples and includes various modification examples. For example, the above-described examples have been described in detail for better understanding of the present invention and are not necessarily limited to those having all the configurations described. Apart of the configuration of one example can be replaced with the configuration of another example, and the configuration of another example can be added to the configuration of one example. It is possible to add, delete, and replace other configurations for a part of the configuration of each example.

Each of the above-described configurations, functions, processing units, processing means, and the like may be realized by hardware by designing a part or all thereof with, for example, an integrated circuit. Each of the above-described configurations, functions, and the like may be realized by software by a processor interpreting and executing a program that realizes each function. Information such as programs, tables, and files that realize each function can be stored in a data storage medium such as a non-volatile semiconductor memory, a hard disk drive, a solid state drive (SSD), or a computer-readable non-transitory data storage medium such as an IC card, SD card, or DVD.

The control lines and information lines indicate what is considered necessary for the description, and not all the control lines and information lines are necessarily shown on the product. Actually, it may be considered that almost all the components are connected to each other.

What is claimed is:

1. A carrier system including a plurality of carriers and a control unit, wherein
each carrier included in the plurality of carriers includes a sensor that detects an object,
the control unit
stores carrier information indicating a position of a first carrier of the plurality of carriers and
transmits an instruction to check existence of a second carrier to the first carrier when identification information and a position of the second carrier of the plurality of carriers are input,
the first carrier having received the instruction to check existence performs measurement by the sensor and transmits a result of the performed measurement to the control unit, and
the control unit determines whether the input position of the second carrier is correct based on the result of measurement by the sensor received from the first carrier.

2. The carrier system according to claim 1, wherein
the carrier information includes a position and a direction of at least one of the plurality of carriers,
the control unit
further stores map information of a space in which the plurality of carriers travel,
selects a carrier that is a carrier other than the second carrier and of which a position and a direction are included in the carrier information as the first carrier from the plurality of carriers when the identification information, the position, and a direction of the second carrier are input,
generates a route having a position of the first carrier as a start point and an end point at a position where a relationship with the input position of the second carrier satisfies a predetermined condition, based on the map information,
determines a direction in which the second carrier and the first carrier at the end point are to face based on a relationship between the end point and the input position of the second carrier,
transmits the generated route and an instruction for directing to the determined direction in which the first carrier is to face, to the first carrier, and
transmits an instruction for directing to the determined direction in which the second carrier is to face, to the second carrier,
the second carrier changes the direction so that the second carrier faces in the determined direction in which the second carrier is to face, and
the first carrier moves along the received route to the endpoint, changes the direction so that the first carrier faces in the determined direction in which the first carrier is to face, and then performs measurement by the sensor.

3. The carrier system according to claim 2, wherein
the sensor is a distance sensor that measures a distance to an object,
the map information is information in which a space in which the plurality of carriers travel is divided into grid-shaped sections,
the end point is a section adjacent to a section where the input second carrier is located,
each carrier stores shape information indicating a shape of each carrier, and
the first carrier compares a shape of the object measured by the sensor with the stored shape information to transmit the result to the control unit as a result of the measurement by the sensor.

4. The carrier system according to claim 3, wherein
the direction in which the first carrier is to face and the direction in which the second carrier is to face are a direction in which a surface of the first carrier on which the sensor is installed and a surface of the second carrier on which the sensor is installed face to each other, and
the first carrier compares the shape of the object measured by the sensor with a shape of the surface on which the sensor of each carrier included in the stored shape information is installed to transmit the result to the control unit as a result of the measurement by the sensor.

5. The carrier system according to claim 3, wherein
after the measurement by the sensor of the first carrier is completed, the control unit transmits a change instruction for changing a facing direction by a predetermined angle to the second carrier,
after the change instruction is transmitted, the first carrier performs measurement by the sensor again, and
the control unit determines whether the input position and direction of the second carrier are correct based on the result of the measurement performed before the change instruction is transmitted and the result of the measurement performed after the change instruction is transmitted.

6. The carrier system according to claim 5, wherein
before or after transmitting the change instruction, the control unit transmits a direction in which the second carrier is to face and the change instruction so that the surface of the second carrier on which the sensor is installed faces the first carrier.

7. The carrier system according to claim 5, wherein
the sensor is a laser distance sensor that measures the distance to the object and a reflection intensity from the object,
outer peripheral surfaces of each carrier include a first surface having a first reflection intensity, and a second surface including a portion having a second reflection intensity different from the first reflection intensity,
the carrier information includes information of the reflection intensity for each outer peripheral surface of each carrier,
the control unit
transmits an instruction to change the direction in which the second carrier is facing from a direction in which the first surface faces the first carrier to a direction in which the second surface faces the first carrier after a first time of measurement by the sensor of the first carrier has been completed and
determines whether the input position and direction of the second carrier are correct based on a measurement result of a reflection intensity performed before the change of the direction of the second carrier and a measurement result of a reflection intensity performed after the change.

8. The carrier system according to claim 2, further comprising:
a display unit that displays a map of an area including the input position of the second carrier, and the input position of the second carrier on the map in the space in which the plurality of carriers travel, based on the map information.

9. The carrier system according to claim 8, wherein
the map information includes a position of a sign that is actually displayed in the space in which the plurality of carriers travel, and
the display unit displays a position and a meaning of the sign included in an area displayed by the display unit based on the map information in the space in which the plurality of carriers travel.

10. The carrier system according to claim 8, wherein
the control unit further stores shelf arrangement information indicating positions of a plurality of shelves placed in the space in which the plurality of carriers travel and identification information of each shelf, and
the display unit displays a position and the identification information of the shelf included in an area displayed by the display unit in the space in which the plurality of carriers travel, based on the map information and the shelf arrangement information.

11. The carrier system according to claim 8, wherein
each carrier
stores an environment map indicating a position of an object in a space in which the plurality of carriers travel and
stores a result of estimating a position of each carrier by comparing a measurement result of the sensor with the environment map,
the control unit acquires a latest position estimated by the second carrier from the second carrier, and
the display unit acquires the latest position of the second carrier from the control unit and displays the latest position on the map.

12. The carrier system according to claim 2, wherein
the control unit further stores shelf arrangement information indicating positions of a plurality of shelves placed in the space in which the plurality of carriers travel,
the carrier information includes information indicating whether the first carrier is carrying any of the shelves, and
when the first carrier is carrying any of the shelves, the control unit generates the route so that the first carrier does not pass under another shelf based on the shelf arrangement information and the carrier information.

13. The carrier system according to claim 1, further comprising:
a display unit, wherein
the control unit
further stores map information of a space in which the plurality of carriers travel,
specifies a position of the first carrier based on the carrier information and outputs the position to the display unit when the identification information of the first carrier is input before the identification information, the position, and a direction of the second carrier are input, and
the display unit displays a map of an area including the position of the specified first carrier and the position of the specified first carrier on the map in the space in which the plurality of carriers travel, based on the map information.

14. A carrier control system that controls a plurality of carriers, the system comprising:
a processor;
a storage device that is connected to the processor; and
a communication device that is connected to the processor and communicates with the plurality of carriers via a network, wherein
each carrier included in the plurality of carriers includes a sensor that detects an object,
the storage device stores carrier information indicating a position of a first carrier of the plurality of carriers, and
the processor
transmits an instruction to check existence of a second carrier to a first carrier via the communication device when identification information and a position of the second carrier of the plurality of carriers are input, and
determines whether the input position of the second carrier is correct based on a received measurement result when receiving the result of measurement by the sensor from the first carrier via the communication device.

15. A carrier control method in a carrier system that includes a plurality of carriers and a control unit, wherein
each carrier included in the plurality of carriers includes a sensor that detects an object,
the control unit stores carrier information indicating a position of a first carrier of the plurality of carriers, and
the carrier control method includes
a procedure of transmitting an instruction to check existence of a second carrier to the first carrier when identification information and a position of the second carrier of the plurality of carriers are input by the control unit,
a procedure of performing measurement by the sensor when the first carrier receives the instruction to check existence and transmitting a result of the performed measurement to the control unit by the first carrier, and
a procedure of determining whether the input position of the second carrier is correct based on the result of measurement by the sensor received from the first carrier by the control unit.
